(19) United States
(12) Patent Application Publication
(10) Pub. No.: US 2024/0042643 A1
(43) Pub. Date: Feb. 8, 2024

(54) TOOL CLAMPING ASSEMBLY AND ASSEMBLY

(71) Applicant: BOBST MEX SA, Mex (CH)

(72) Inventors: Adem UYAR, Saint-Julien-en-Genevois (FR); Patrice CHATRY, Lugrin (FR)

(73) Assignee: BOBST MEX SA, Mex (CH)

(21) Appl. No.: 18/257,198

(22) PCT Filed: Dec. 15, 2021
(86) PCT No.: PCT/EP2021/085985

§ 371 Date: Jun. 13, 2023

(30) Foreign Application Priority Data
Dec. 17, 2020 (EP) 20215093.4

(51) Int. Cl. B26D 7/18

(52) U.S. Cl. CPC B26D 7/1818; B26D 2007/189

(57) ABSTRACT

A tool clamping assembly (38) for clamping a blanking tool (40) intended to be used in a blanking station of a sheet processing machine has a frame (46) to which the blanking tool (40) is to be clamped and at least one clamping element (48). The frame (46) has an aligning mechanism adapted for aligning the blanking tool (40) in a first direction. Further, the frame (40) has at least one support surface (60) oriented to support the blanking tool (40) in a second direction which is perpendicular to the first direction, and at least one abutment surface (62) oriented to support the blanking tool (40) in a third direction which is perpendicular to the first and second directions. The clamping element (48) is displaceable between an open position and a clamping position, the clamping element (48) being adapted for clamping the blanking tool (40) against both the support surface (60) and the abutment surface (62).

Further, a blanking tool assembly with such a tool clamping assembly is shown.

The invention relates to a tool clamping assembly for clamping a blanking tool and an assembly comprising said tool clamping assembly.

Sheet processing machines, also known as converting machines, are used in the packaging industry for processing raw materials, e.g. cardboard, paper or foils, into intermediate or finished products, typically in the form of sheets. Converting operations can e.g. include printing, cutting, creasing, blanking, stamping, and/or folding-gluing. Typically, the individual operations are done in subsequent processing stations of the sheet processing machine, with the sheets being conveyed from one processing station to the subsequent one by a transport mechanism. The sheets can be collected in vertical stacks after converting in a designated piling area of the sheet processing machine.

Blanking operations involve breaking nicks in sheets, which have been formed in a previous processing step. This results in punching out blanks from the sheets. For this purpose, the blanking station can e.g. comprise an upper male blanking tool and a lower female blanking tool vertically assembled one above the other. The upper blanking tool is made of pushing devices slightly smaller than the perimeter of the blanks. The lower blanking tool is made of longitudinal and transverse bars forming a grid corresponding to the perimeter of the blanks. The blanks can fall through the spaces of this grid and pile up vertically when the upper blanking tool is lowered.

The quality of this blanking operation depends on a correct alignment of the blanking tools used in the respective blanking station. Therefore, mechanisms for aligning and securing the position of the used blanking tools are necessary. Typically, blanking tools must be changed between different production batches to correspond to the shape and/or size of the desired blanks. To reduce downtimes of the sheet processing machine, there exists a need for mechanisms which allow for a fast exchange of the blanking tools while providing reliable alignment of said blanking tools.

The object of the invention is to provide an easy means to align and fasten a blanking tool.

The object of the invention is solved by a tool clamping assembly for clamping a blanking tool intended to be used in a blanking station of a sheet processing machine, the tool clamping assembly having a frame to which the blanking tool is to be clamped, and at least one clamping element. The frame has an aligning mechanism adapted for aligning the blanking tool in a first direction. Further, the frame has at least one support surface oriented to support the blanking tool in a second direction, which is perpendicular to the first direction, and at least one abutment surface oriented to support the blanking tool in a third direction, which is perpendicular to the first and second directions. The clamping element is displaceable between an open position and a clamping position, the clamping element being adapted for clamping the blanking tool against both the support surface and the abutment surface.

The invention is based on the idea to provide a means for securing the blanking tool against movements in all directions by a combination of two simple mechanisms, i.e. by a combination of the alignment mechanism and of the clamping element.

To further ensure a secured position of the blanking tool, the clamping element especially applies a clamping force on the blanking tool in the clamping position, wherein the clamping surface has a force component along the second direction and a force component along the third direction. Accordingly, the clamping can be adapted to secure the position of the blanking tool in two perpendicular directions at the same time.

To allow for an easy transition between the open position and the clamping position, the clamping element can be displaceable between the open position and the clamping position by a movement along the second direction, especially by a movement initiated by a piston arranged in the frame and connected to the clamping element.

In one variant, the clamping element is connected to the frame by a carrier element, wherein the carrier element is associated to the frame with a first end section and associated to the clamping element with a second end section.

Preferably, the carrier element is connected to the piston at the first end section. Therefore, the clamping element can be displaced between the open position and the clamping position, or vice versa, by a movement of the piston by means of the carrier element.

Several clamping elements can be connected to the same carrier element. Also, the tool clamping assembly can comprise a carrier element for each of the clamping elements.

The clamping element can be rotatably connected to the carrier element to allow for a change of the alignment of the clamping element between the open position and the clamping position.

In one embodiment, the clamping element and the carrier element can be connected by a pin of the carrier element and a sleeve or bushing of the clamping element.

The clamping element can be rotatably connected to the carrier element with a first end section and be adapted to rotate with a second end section towards the carrier element when being displaced between the open position and the clamping position, wherein the second end section is adapted for clamping the blanking tool against the support surface and the abutment surface of the frame. In this way, an especially simple and fast mechanism is provided, which allows for a quick exchange and secure fastening of the blanking tool.

The clamping element and the carrier element especially form an angle of less than 90° relative to each other in the open position of the clamping element. This provides an arrangement of the clamping element and the carrier element relative to each other in which the carrier element effectively forms a protrusion, which can be used for interaction with the blanking tool.

Further, if the clamping element and the carrier element are rotatably connected to each other, a preferred rotation direction can be provided. Preferably, in this variant, the minimum angle between the clamping element and the carrier element in the open position is 10°.

In another variant, the tool clamping assembly further comprises a leaf spring connected to the clamping element, especially a leaf spring further connecting the clamping element and the carrier element. The leaf spring can hold the clamping element in a tilted state in the open position to ensure a correct relative alignment of the clamping element to the carrier element while still allowing a relative movement of the carrier element when being displaced between the open position and the clamping position. At the same time, the leaf spring can be used to re-align the clamping element when being displaced from the clamping position to the open position.

Further, the carrier element can comprise a cover arranged at the second end section. The cover can prevent the carrier element from moving, especially rotating, in the direction of the cover to prevent misalignments of the carrier element.

The aligning mechanism is preferably connected to the frame. In one embodiment, the aligning mechanism is a clamp mounted on the frame.

The object of the invention is further solved by a blanking tool assembly comprising a tool clamping assembly as described before and a blanking tool.

The clamping element especially presses against a contact surface of the blanking tool in the clamping position, wherein the contact surface is especially located in a corner of a receiving space of the blanking tool. Accordingly, the blanking tool is pressed against the support surface and the abutment surface of the frame by the clamping element pressing against the contact surface of the blanking tool. In other words, the blanking tool is secured along the second and third directions by clamping the blanking tool between the support surface, the abutment surface, and the clamping element.

The contact surface can be part of a step structure of the blanking tool. The step structure can be adapted to cooperate with further components of the tool clamping assembly, e.g., with the cover of the carrier element.

To provide a flat surface of the blanking tool, the blanking tool can have a recess in which the clamping element can be incorporated, especially the clamping element and the carrier element when the clamping element is in the clamping position.

Further, the aligning mechanism can cooperate with an alignment protrusion of the blanking tool. In other words, the blanking tool can comprise an alignment protrusion, which is used to align the blanking tool by the aligning mechanism of the frame. In one embodiment, the aligning mechanism can be a trapezoidal clamp interacting with the alignment protrusion to prevent movements of the blanking tool in the first direction.

Further advantages and features will become apparent from the following description of the invention and from the appended figures which show non-limiting exemplary embodiments of the invention and in which:

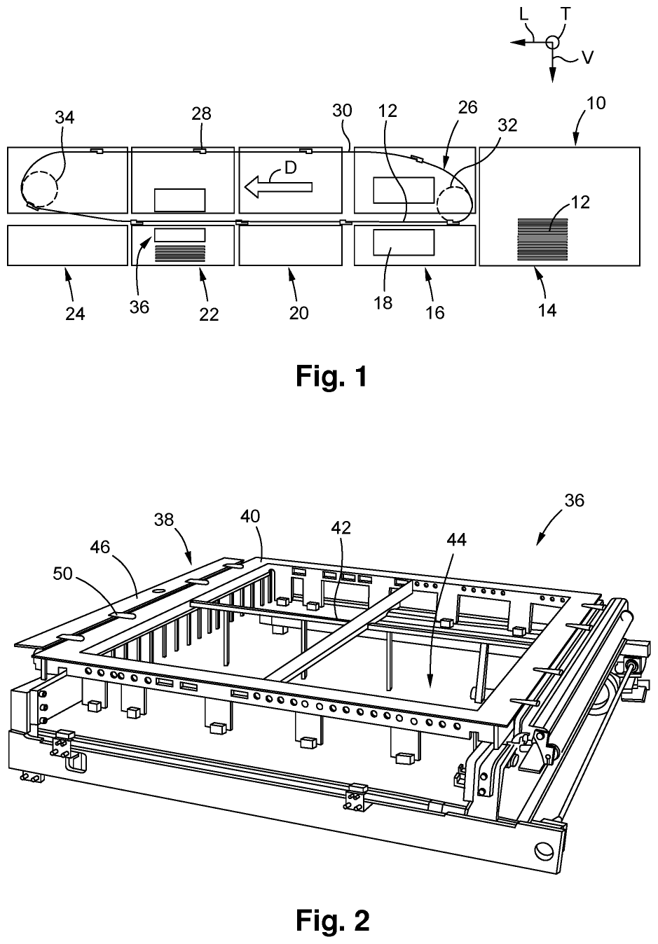

FIG. 1 schematically shows a sheet processing machine comprising a blanking tool assembly according to the invention;

FIG. 2 shows a perspective view on the blanking tool assembly of FIG. 1 comprising a first embodiment of the tool clamping assembly according to the invention;

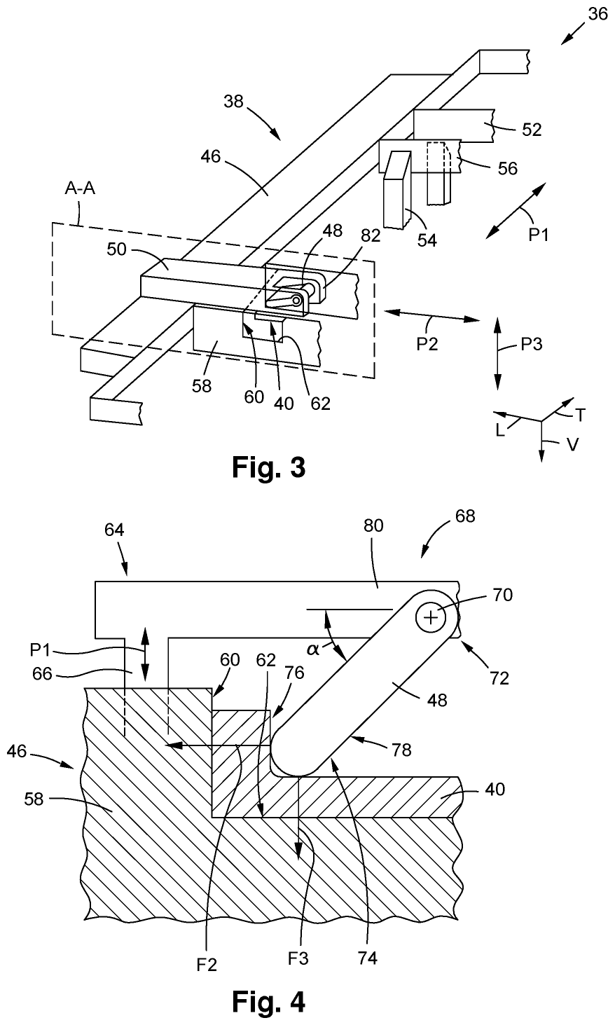

FIG. 3 schematically shows in a perspective view the blanking tool assembly of FIG. 2;

FIG. 4 schematically shows a cut of the blanking tool assembly along the plane A-A of FIG. 3;

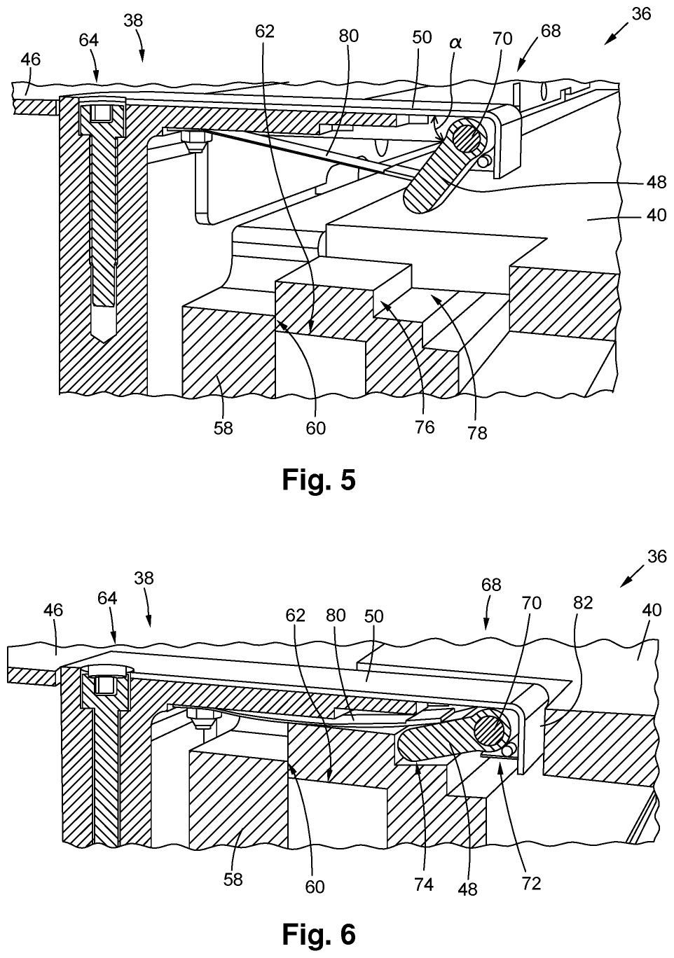

FIG. 5 shows a perspective view of a second embodiment of the tool clamping assembly according to the invention with a clamping element in an open position; and

FIG. 6 shows the tool clamping assembly of FIG. 6 with the clamping element in a clamping position.

FIG. 1 schematically shows a sheet processing machine 10 making it possible to cut blanks from a succession of sheets 12. These blanks are usually intended to be subsequently folded and bonded to form packaging boxes. However, the sheets 12 might generally be made of e.g. paper, cardboard, foil or any other material routinely used in the packaging industry.

The sheet processing machine 10 comprises a series of processing stations that are juxtaposed but interdependent one another in order to form a unitary assembly. The processing machine 10 includes a feeder station 14 followed by a cutting station 16 (also usually named punching station) comprising for example a die or platen press 18 where the sheets 12 are transformed by cutting, a waste stripping station 20 wherein most of the waste parts are stripped, a blanking station 22 (also usually named reception station) for separation of the blanks (or blanking operation) and an evacuation station 24 for removing the residual waste sheets of the punched sheets 12.

The number and nature of the processing stations may vary depending on the nature and the complexity of the converting operations to be carried out on the sheets 12.

The sheet processing machine 10 also has a conveyor 26 to make it possible to individually move each sheet 12 from an outlet of the feeder station 14 to the evacuation station 24.

The conveyor 26 uses a series of gripper bars 28 that are mounted so as to be moveable by means of two loops of chains 30 one placed laterally on each side of the sheet processing machine 10. Each loop of chains 30 travels around a loop, which allows the gripper bars 28 to follow a trajectory passing successively by the cutting station 16, the waste stripping station 20, the blanking station 22, and the evacuation station 24.

Each gripper bar 28 travels on an outward path in a substantially horizontal plane of passage between a driven wheel 32 and an idler wheel 34, and then a return path in the top portion of the sheet processing machine 10. Once returned to the driven wheel 32, each gripper bar 28 is then able to grip a new sheet 12 at an front edge of the sheet 12.

In FIG. 1, each processing station is illustrated in the form of two rectangles symbolizing respectively its top portion and its bottom portion that are positioned on each side of the plane of movement of the sheets 12.

In FIG. 1, a transverse (or lateral), longitudinal and vertical direction are indicated by the orthogonal spatial system (T, L, V). In the following, these directions will also be denoted first, second and third direction, respectively.

The terms “upstream” and “downstream” are defined with reference to the direction of movement of sheets 12 in the second direction L as illustrated by the arrow Din FIG. 1.

The blanking station 22 comprises a blanking tool assembly 36 according to the invention which is shown in FIG. 2 in more detail.

The blanking tool assembly 36 comprises a tool clamping assembly 38 and a blanking tool 40.

The blanking tool 40 shown in FIG. 2 is a lower blanking tool, i.e. it is made of longitudinal and transverse bars 42 forming a grid corresponding to the perimeter of the blanks, which are to be cut out of the sheets 12 (see FIG. 1). The blanks can fall through spaces 44 of this grid and pile up vertically (see. FIG. 1).

The tool clamping assembly 38 comprises a frame 46 and a multitude of clamping elements 48 (see FIG. 3), which are connected by carrier elements 50 to the frame 46, wherein each clamping element 48 is associated to one of the carrier elements 50.

In FIG. 3, selected parts of the blanking tool assembly 36 are shown.

The blanking tool 40 comprises an alignment protrusion 52, which cooperates with an aligning mechanism 54 of the clamping tool assembly 38. In the shown embodiment, the aligning mechanism 54 is a trapezoidal clamp interacting with side surfaces 56 of the alignment protrusion 52.

Further, the blanking tool 40 rests in a reception part 58 of the frame 46, wherein the reception part 58 comprises a support surface 60 and an abutment surface 62.

The clamping elements 48 are cams that are rotatably connected to the respective carrier elements 50.

This arrangement is shown in more detail in FIG. 4, which is a cut along the plane A-A indicated in FIG. 3.

The carrier element 50 is associated with the frame 46 at a first end section 64 of the carrier element 50 by means of a piston 66. The piston 66 is movable along the third direction (i.e., vertically), as indicated by the arrow P₃ in FIG. 4.

The clamping element 48 is connected with the carrier element 50 at a second end section 68 of the carrier element 50 by means of a pin 70 received in a bushing of the clamping element 48.

The bushing of the clamping element 48 is arranged at a first end section 72 of the clamping element 48. A second end section 74 at the opposite end of the clamping element 48 is pressing against a contact surface 76 of a receiving space 78 of the blanking tool 40.

The clamping element 48 and the carrier element 50 are oriented relative to each other such that they form an angle α, which preferably is less than 90°, i.e. the second end section 74 of the clamping element 48 points towards the receiving space 78 of the blanking tool 40.

In the following, the mode of action of the tool clamping assembly 38 will be described.

When a blanking tool 40 shall be secured in the blanking station 22 (see. FIG. 1), in a first step, the blanking tool 40 is aligned above the frame 46 such that by lowering the blanking tool 40, i.e. by moving the blanking tool 40 along the third direction, the alignment protrusion 52 gets aligned between the trapezoidal portions of the aligning mechanism 54. Accordingly, the blanking tool 40 is secured against movements along the first direction, as indicated by arrow P₁ in FIG. 3.

At this point, the clamping element 48 is in an open position, i.e. the clamping element 48 does not apply a force on the blanking tool 40.

In a second step, the piston 66 is moved, e.g. by a (not shown) linear drive, along the third direction, i.e. vertically down. Therefore, the clamping element 48 comes into contact with the contact surface 76 of the blanking tool 40. Further, the clamping element 48 rotates with its second end section 74 towards the carrier element 50 until the second end section 74 gets locked in a corner of the receiving space 78 of the blanking tool 40 as shown in FIG. 4.

In this clamping position of the clamping element 48, a force is applied by the clamping element 48 on the blanking tool 40 which has a force component F₂ and a force component F₃ indicated by arrows in FIG. 4.

This results in pressing the blanking tool 40 along the second direction against the support surface 60 and along the third direction against the abutment surface 62.

In other words, the blanking tool 40 is clamped between the reception part 58 of the frame 46 and the clamping element 48 and prevents the blanking tool from moving along the second and third directions, as indicated by arrows P₂ and P₃ in FIG. 3.

If the blanking tool 40 shall be removed or exchanged, this simple two-step process can be done in reversed order.

Accordingly, the blanking tool assembly according to the invention provides a very simple, easy to use and reliable mechanism for use in a blanking station 22 of a sheet processing machine 10.

FIGS. 5 and 6 show selected parts of a second embodiment of the tool clamping assembly 38. The second embodiment essentially corresponds to the first embodiment so that only differences between the first and the second embodiment will be discussed in the following. Identical and functionally identical components are provided with the same reference signs.

In the second embodiment, the tool clamping assembly 38 further comprises a leaf spring 80 which is connected to the clamping element 48 and to the carrier element 50, wherein the connection to the carrier element 50 is closer to the first end section 64 of the carrier element 50 than to the second end section 68 of the carrier element 50.

Further, the embodiment shown in FIG. 5 comprises a cover 82.

In the open position of the clamping element 48 shown in FIG. 5, the leaf spring 80 is relaxed and defines the angle α between the carrier element 50 and the clamping element 48. Stated differently, the second end section 74 of the clamping element 48 cannot rotate closer towards the cover 82 than defined by the leaf spring 80.

In the clamping position of the clamping element 48 shown in FIG. 6, the leaf spring 80 is kept under tension. Therefore, as soon as the clamping element 48 is displaced back to the open position, the leaf spring 80 relaxes and pushes the clamping element 48 back to the position shown in FIG. 5.

Accordingly, the orientation of the clamping element 48 is well defined at any point during operation of the tool clamping assembly 38.

1. A clamping assembly for clamping a blanking tool intended to be used in a blanking station of a sheet processing machine,
the tool clamping assembly having a frame to which the blanking tool is to be clamped, and at least one clamping element,
the frame having an aligning mechanism adapted for aligning the blanking tool in a first direction,
the frame further having at least one support surface oriented to support the blanking tool in a second direction which is perpendicular to the first direction, and at least one abutment surface oriented to support the blanking tool in a third direction which is perpendicular to the first and second directions, and
the clamping element being displaceable between an open position and a clamping position, the clamping element being adapted for clamping the blanking tool against both the support surface and the abutment surface,
wherein the clamping element applies a clamping force on the blanking tool in the clamping position, wherein the clamping force has a force component along the second direction and a force component along the third direction.

2. The tool clamping assembly according to claim 1, wherein the clamping element is displaceable between the open position and the clamping position by a movement along the second direction, especially by a movement initiated by a piston arranged in the frame and connected to the clamping element.

3. The tool clamping assembly according to claim 1, wherein the clamping element is connected to the frame by a carrier element, wherein the carrier element is associated to the frame with a first end section and associated to the clamping element with a second end section.

4. The tool clamping assembly according to claim 3, wherein the clamping element is rotatably connected to the carrier element.

5. The tool clamping assembly according to claim 4, wherein the clamping element is rotatably connected to the carrier element with a first end section and is adapted to rotate with a second end section towards the carrier element when being displaced between the open position and the clamping position, wherein the second end section is adapted for clamping the blanking tool against the support surface and the abutment surface of the frame.

6. The tool clamping assembly according to claim 3, wherein the clamping element and the carrier element form an angle of less than 90° relative to each other in the open position of the clamping element.

7. The tool clamping assembly according to claim 3, wherein the tool clamping assembly further comprises a leaf spring connected to the clamping element, especially a leaf spring further connecting the clamping element and the carrier element.

8. The tool clamping assembly according to claim 3, wherein the carrier element comprises a cover arranged at the second end section.

9. The tool clamping assembly according to claim 1, wherein the aligning mechanism is connected to the frame.

10. A blanking tool assembly comprising the tool clamping assembly according to claim 3 and a blanking tool.

11. The blanking tool assembly according to claim 10, wherein the clamping element in the clamping position presses against a contact surface located in a corner of a receiving space of the blanking tool.

12. The blanking tool assembly according to claim 11, wherein the contact surface of the blanking tool is part of a step structure of the blanking tool.

13. The blanking tool assembly according to claim 10, wherein the blanking tool has a recess in which the clamping element, especially the clamping element and the carrier element, can be incorporated when the clamping element is in the clamped position.

14. The blanking tool assembly according to claim 10, wherein the aligning mechanism cooperates with an alignment protrusion of the blanking tool.
